(19) United States
(12) Patent Application Publication
(10) Pub. No.: US 2020/0012215 A1
(43) Pub. Date: Jan. 9, 2020

(54) IMAGE FORMING APPARATUS CAPABLE OF PREDICTING TEMPERATURE

(71) Applicant: CANON KABUSHIKI KAISHA, Tokyo (JP)

(72) Inventor: Masaki Kobayashi, Suntou-gun (JP)

(21) Appl. No.: 16/448,240

(22) Filed: Jun. 21, 2019

(30) Foreign Application Priority Data
Jul. 3, 2018 (JP) 2018-126986

(51) Int. Cl. G03G 15/20

(52) U.S. Cl. CPC G03G 15/2039

(57) ABSTRACT

The image forming apparatus includes a prediction unit configured to predict a temperature of an inside of the image forming apparatus based on data indicating a characteristic of a change in temperature of the inside of the image forming apparatus; and a correction unit configured to correct the data based on a temperature distribution of the recording material heated by a plurality of heat generation devices, wherein the prediction unit predicts the temperature of the inside of the image forming apparatus based on the data corrected by the correction unit.

### BACKGROUND OF THE INVENTION

### Field of the Invention

The present invention relates to an electrophotographic image forming apparatus, particularly to a technique to predict a temperature of an interior of an image forming apparatus.

### Description of the Related Art

When an electrophotographic image forming apparatus, such as a copying machine and a printer, performs image forming operations continuously on recording materials, a temperature of an interior of the image forming apparatus (hereinafter, referred to as an interior) rises (hereinafter, referred to as a temperature rise). If the interior causes an excessive temperature rise, the temperature rise can affect a quality of an image formed on a recording material. Examples of a member that affects a quality of an image by the temperature rise include a blade, which is used to remove toner left on an image bearing member such as a photosensitive drum and an intermediate transfer belt. By abutting the image bearing member, the blade can remove toner not transferred to a recording material but left on the image bearing member, but the blade causes a temperature rise under an influence of friction. Toner has a property of melting by heat. Therefore, when a temperature of the blade reaches around a fusing point of toner, fusion of toner occurs at an edge of the blade, which brings about poor cleaning. That is, melted toner passes the blade to be left on the image bearing member and can affect a quality of an image to be formed next.

Hence, a control that predicts a temperature of an interior of the image forming apparatus (hereinafter, referred to as an in-apparatus temperature) and switches an operation mode of the image forming apparatus according to the predicted in-apparatus temperature, has been proposed (e.g., see Japanese Patent No. 4781217). In this control, a temperature of a blade is predicted based on an ambient environment temperature of the image forming apparatus and a temperature rise profile preset for each operation mode. Then, before the blade causes a temperature rise to a temperature at which the poor cleaning described above can occur, an operation mode of the image forming apparatus is switched to a temperature rise protection mode in which the temperature rise of the blade is prevented. This temperature rise protection mode prevents an excessive temperature rise of the blade. Here, the temperature rise protection mode corresponds to, for example, an intermittent operation that alternates the image forming operation and a suspending operation at an interval of a certain time period, which causes a decrease in throughput as compared with regular operation modes.

One of heat sources in an image forming apparatus is a fixing device. For the fixing device, a method in which an image formed on a recording material is heated selectively is used in some cases (e.g., see Japanese Patent Application Laid-Open No. H06-095540). In such a fixing device, a recording material can be heated selectively for each of heating areas divided in a direction orthogonal to a conveyance direction of the recording material (hereinafter, referred to as a longitudinal direction).

Here, in a case where a configuration described in Japanese Patent Application Laid-Open No. H06-095540 is adopted and a recording material is heated selectively, positions and dimensions where the recording material causes a temperature rise are limited as compared with a case where the entire recording material is heated, and thus unevenness develops in a temperature distribution of the recording material. As a result, in a case of double-side-print, particularly, a quantity of heat traveling from the recording material with an increased temperature through the fixing device to a processing member becomes small, or dimensions of the processing member to which the heat travels become small. The process members refer to members involved in the image formation. As a result, if the in-apparatus temperature is predicted without consideration of a temperature distribution of a recording material in a case where an image formed on the recording material is heated selectively, the following problem arises. That is, although the in-apparatus temperature does not increase to a temperature at which the in-apparatus temperature affects an image quality, the operation mode of the apparatus is switched to the temperature rise protection mode in many usage environments. That is, a throughput of the image forming apparatus will decrease with a timing earlier by some margin than a timing at which the in-apparatus temperature reaches a temperature at which the poor cleaning can occur, which may results in a degradation in usability.

### SUMMARY OF THE INVENTION

An aspect of the present invention is an image forming apparatus including an image formation unit configured to form an image on a recording material, a fixing unit including a plurality of heat generation devices in an orthogonal direction orthogonal to a conveyance direction of the recording material, the fixing unit being configured to fix a toner image unfixed that is formed on the recording material by the image formation unit, a prediction unit configured to predict a temperature of an inside of the image forming apparatus based on data indicating a characteristic of a change in temperature of the inside of the image forming apparatus, and a correction unit configured to correct the data based on a temperature distribution of the recording material heated by the plurality of heat generation devices, wherein the prediction unit predicts the temperature of the inside of the image forming apparatus based on the data corrected by the correction unit.

Further features of the present invention will become apparent from the following description of exemplary embodiments with reference to the attached drawings.

### BRIEF DESCRIPTION OF THE DRAWINGS

FIG. 1A is a cross-sectional view of an image forming apparatus in Embodiments 1 to 3.

FIG. 1B is a schematic cross-sectional view of a fixing device.

FIG. 2A, FIG. 2B, and FIG. 2C are schematic cross-sectional views of a heater in Embodiments 1 to 3.

FIG. 3 is a diagram illustrating heating areas in Embodiments 1 to 3.

FIG. 4 is a diagram illustrating an image and image heating portions in Embodiments 1 to 3.

FIG. 5 is a functional block diagram of a control unit in Embodiment 1.

FIG. 6 is a flowchart of temperature rise protection control in Embodiments 1 to 3.

FIG. 7 is a graph illustrating measured values of an in-apparatus temperature and predicted values by a temperature rise counter in Embodiments 1 to 3.

FIG. 8 is a functional block diagram of a control unit in Embodiment 2.

FIG. 9 is a functional block diagram of a control unit in Embodiment 3.

### DESCRIPTION OF THE EMBODIMENTS

Preferred embodiments of the present invention will now be described in detail in accordance with the accompanying drawings.

Embodiments of the present invention will be described below with reference to the accompanying drawings. Note that embodiments described below are merely an example and should not be construed as limiting on the scope of the present invention to the embodiments.

### Embodiment 1

[Overview of Image Forming Apparatus]

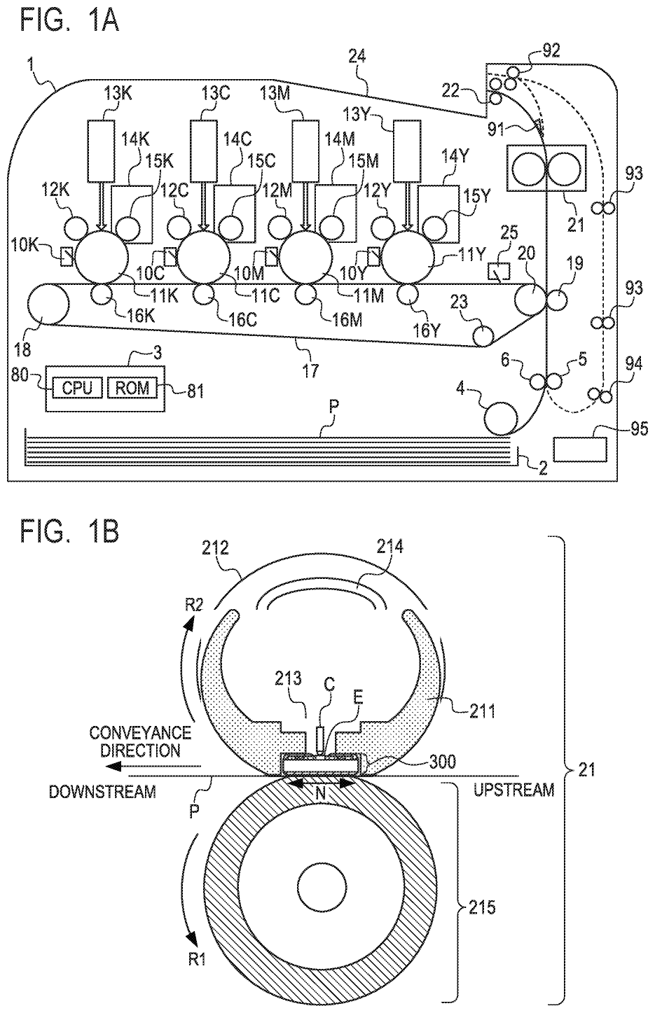

In Embodiment 1, an electrophotographic laser beam printer 1 (hereinafter, referred to as a printer 1) as an image forming apparatus. FIG. 1A is a configuration diagram of the printer 1. The printer 1 is a tandem-type color printer and capable of forming a color image on a recording material P by superimposing toners (developers) of four colors including yellow (Y), magenta (M), cyan (C) and black (K). In the following description, members for which distinctions of colors: yellow, magenta, cyan and black need not be positively made will be denoted without indices Y, M, C and K for convenience of description. The printer 1 includes a cassette 2, a control unit 3, a feeding roller 4, a conveyance roller 5, and an opposing conveyance roller 6. The printer 1 includes photosensitive drums 11, charging rollers 12, optical units 13, developing units 14, developer conveyance rollers 15, primary transfer rollers 16, and drum cleaners 10. The printer 1 includes an intermediate transfer belt 17, a drive roller 18, a tension roller 23, a secondary transfer roller 19 (transfer unit), an opposing secondary transfer roller 20, and a belt cleaner 25. The printer 1 includes a fixing device 21, a discharge roller 22, a discharge tray 24, a flapper 91, a reverse roller 92, double-side-print conveyance rollers 93 and 94, and an environment sensor 95.

The cassette 2 stores recording materials P. The control unit 3 is a control unit for controlling operation of the printer 1 and includes a CPU 80 and ROM 81. Functions of the control unit 3 will be described later in detail. The opposing conveyance roller 6 is a feeding roller for feeding a recording material P from the cassette 2. The conveyance roller 5 is a roller for conveying a recording material P fed by the feeding roller 4, and the opposing conveyance roller 6 is a roller opposing the conveyance roller 5. The photosensitive drums 11 bear toners of the respective colors. The charging rollers 12 places a uniform charge on the photosensitive drums 11, bringing the photosensitive drums 11 to a predetermined electric potential. The optical units 13 irradiate the charged photosensitive drums 11 with laser beams corresponding to image data items of the respective colors, forming electrostatic latent images. The developing units 14 make the electrostatic latent images formed on the photosensitive drums 11 visible, forming toner images. The developer conveyance rollers 15 are rollers for feeding the toners in the developing units 14 to the photosensitive drums 11. The primary transfer rollers 16 transfer the toner images formed on the photosensitive drums 11 on the intermediate transfer belt 17 (hereinafter, this will be referred to as primary transfer). The drum cleaners 10 are drum cleaners for removing toners left on the photosensitive drums 11 after the primary transfer.

The drive roller 18 is a roller for driving the intermediate transfer belt 17, and the tension roller 23 is a roller for applying a tension to the intermediate transfer belt 17. The secondary transfer roller 19 transfers the toner images subjected to the primary transfer on the intermediate transfer belt 17 on the conveyed recording material P (this will be referred to as secondary transfer). The opposing secondary transfer roller 20 is a roller opposing the secondary transfer roller 19. The belt cleaner 25 is a cleaner for removing toner left on the intermediate transfer belt 17 after the secondary transfer. The fixing device 21 fixes the toner images that is subjected to the secondary transfer and unfixed to the recording material P while conveying the recording material P. The discharge roller 22 is a roller for discharging the recording material P on which the toner images are fixed by the fixing device 21, to an outside of the printer 1. The discharge tray 24 is a tray to which the recording material P is discharged. The flapper 91, the reverse roller 92, and the double-side-print conveyance rollers 93 and 94 are used when double-side-print is performed on a recording material P. The environment sensor 95, serving as a sensing unit, is capable of sensing an ambient environment (environment temperature and/or environment humidity) of a place where the printer 1 is installed.

[Image Forming Operation]

Next, an image forming operation of the printer 1 will be described. First, an image forming command and image data are input to the control unit 3 from a host computer (not illustrated). The printer 1 then starts the image forming operation, and a recording material P is fed from the cassette 2 by the feeding roller 4. The recording material P is conveyed by the conveyance roller 5 and the opposing conveyance roller 6 toward a second transfer nipping unit, which is formed by the secondary transfer roller 19 and the opposing secondary transfer roller 20, in such a manner as to be synchronized with the toner images formed on the intermediate transfer belt 17. In synchronization with an action of the recording material P being fed from the cassette 2, a charge is provided to the photosensitive drums 11 to be at a given electric potential by the charging rollers 12. The optical units 13 then expose surfaces of the respective photosensitive drums 11 provided with the charge with laser beams according to the input image data, forming electrostatic latent images. To make the electrostatic latent images visible, the developing unit 14 and the developer conveyance rollers 15 performs development. The electrostatic latent images formed on the surfaces of the photosensitive drum 11 are developed in the respective colors by the developing units 14. The photosensitive drums 11 are in contact with the intermediate transfer belt 17 and rotate in synchronization with rotation of the intermediate transfer belt 17. The developed toner images of the respective colors are transferred from the photosensitive drums 11 on the intermediate transfer belt 17 by the primary transfer rollers 16 in such a manner as to be superimposed on one another in turn. Toners not being transferred on the intermediate transfer belt 17 but left on the photosensitive drums 11 are removed by the drum cleaners 10. The secondary transfer roller 19 and the opposing secondary transfer roller 20 transfer the toner images formed on the intermediate transfer belt 17 on the recording material P. The toner images transferred on the recording material P are heated and pressed by the fixing device 21 to be fixed on the recording material P. Toners not being transferred on the recording material P but left on the intermediate transfer belt 17 are removed by the belt cleaner 25. The above is the image forming operation for a first surface, a front surface of the recording material P.

In a case where the image formation is not performed on a second surface, a back surface of the recording material P (i.e., in a case of single-side-print), the recording material P on which the images are fixed is led by the flapper 91 to a conveyance path provided with the discharge roller 22 and is discharged to the discharge tray 24. This conveyance path is illustrated as a solid line in FIG. 1A. In contrast, in a case where the image formation is also performed on the back surface of the recording material P (i.e., in a case of double-side-print), the recording material P is led by the flapper 91 to a conveyance path provided with the reverse roller 92. This conveyance path is illustrated as a dotted line in FIG. 1A. The reverse roller 92 rotates to convey the recording material P in a direction of discharging the recording material P to the outside, and after a lapse of a predetermined time period after a trailing edge of the recording material P (an edge portion of the recording material P on an upstream side in a conveyance direction) passes the flapper 91, the reverse roller 92 reverses a direction of the rotation. The reverse roller 92 then conveys the recording material P to the double-side-print conveyance roller 93. The double-side-print conveyance roller 93 conveys the recording material P to the double-side-print conveyance roller 94, and the recording material P is once stopped while sandwiched by the double-side-print conveyance roller 94. Afterward, with predetermined timing, the recording material P is conveyed to the conveyance roller 5 and the opposing conveyance roller 6 again, and the back surface of the recording material P is subjected to the image formation as with the front surface. By the above operation, the double-side-print can be performed on the recording material P.

[Configuration of Fixing Device]

FIG. 1B is a cross-sectional view of the fixing device 21 in Embodiment 1. The fixing device 21 includes a fixing film 212 in a form of an endless belt, a heater 300 being in contact with an inner surface of the fixing film 212, a pressing roller 215 forming a fixing nipping unit N together with the heater 300 with the fixing film 212 interposed between the pressing roller 215 and the heater 300, and a metallic stay 214.

The heater 300 is held by a heater holding member 211 made of a heat-resistant resin and is configured to heat the fixing film 212 by heating a heating area provided in the fixing nipping unit N. The heater holding member 211 also has a guidance function of guiding rotation of the fixing film 212. The heater 300 is provided with an electrode E on a side opposite to a side on which the fixing nipping unit N is formed, and electricity is supplied to the electrode E from an electric contact C. The metallic stay 214 receives a pressing force (not illustrated) to urge the heater holding member 211 toward the pressing roller 215. In addition, a safety device 213, such as a thermostatic switch and a thermal fuse, configured to operate in response to abnormal heat generation of the heater 300 to cuts off electricity to be supplied to the heater 300 abuts directly on the heater 300 or indirectly via the heater holding member 211.

The pressing roller 215 receives motive power from a motor (not illustrated) to rotate in an arrow R1 direction. By the rotation of the pressing roller 215, the fixing film 212 accordingly rotates in an arrow R2 direction. In the fixing nipping unit N, by applying heat of the fixing film 212 to the recording material P while sandwiching and conveying the recording material P, the unfixed toner images of the recording material P are subjected to a fixing process. In FIG. 1B, the recording material P is conveyed from the right to the fixing nipping unit N, and an upstream direction and a downstream direction of the conveyance direction are as illustrated.

[Heater]

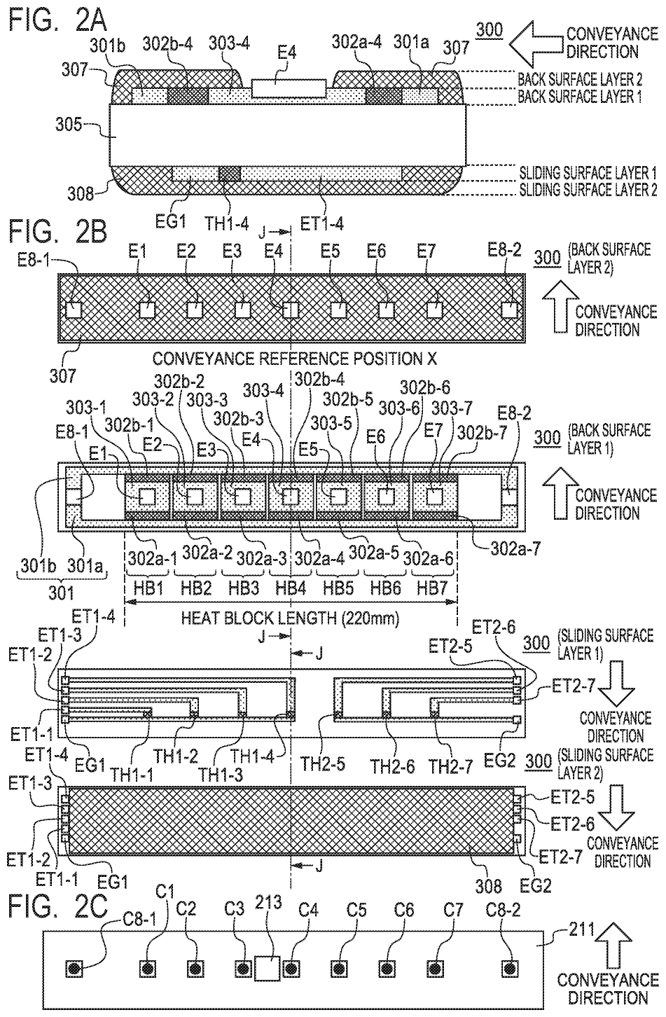

Next, a configuration of the heater 300 in Embodiment 1 will be described with reference to FIG. 2A to FIG. 2C. FIG. 2A is a vertical sectional view of the heater 300 as in FIG. 1B, FIG. 2B is a plan view of layers of the heater 300, and FIG. 2C is a diagram used for describing how the electric contact C is connected to the heater 300. FIG. 2B illustrates a conveyance reference position X for a recording material P in the printer 1 in Embodiment 1. The conveyance reference position X is a position in a direction orthogonal to a conveyance direction, and in conveyance of a recording material P, the conveyance reference position X is used to determine which position in a direction orthogonal to the conveyance direction should be used as a reference to convey the recording material P. In Embodiment 1, a reference of the conveyance is center-based, and the recording material P is conveyed in such a manner that a center line of the recording material P in the direction orthogonal to the conveyance direction passes through the conveyance reference position X. Another reference may be adopted as the reference of the conveyance. FIG. 2A is a vertical sectional view of the heater 300 taken at the conveyance reference position X. That is, FIG. 2A is a cross-sectional view taken along line J-J illustrated as a dash-dot line in FIG. 2B.

As illustrated in FIG. 2A, the heater 300 includes a substrate 305, a first back surface layer, a second back surface layer, a first sliding surface layer, and a second sliding surface layer. The substrate 305 is a substrate made of ceramic. The first back surface layer is provided on the substrate 305. The second back surface layer is a layer covering the first back surface layer. The first sliding surface layer is provided on a side of the substrate 305 opposite to the side on which the first back surface layer is provided. The second sliding surface layer is a layer covering the first sliding surface layer.

As illustrated in FIG. 2B, the first back face layer includes an electric conductor 301 (301a and 301b) provided in a longitudinal direction (right-left direction in FIG. 2B) of the heater 300. The electric conductor 301 is divided into the electric conductor 301a and the electric conductor 301b, and the electric conductor 301b is disposed downstream of the electric conductor 301a in the conveyance direction of the recording material P. The first back surface layer includes an electric conductor 303 (303-1 to 303-7) provided in such a manner as to be parallel to the electric conductors 301a and 301b. The electric conductor 303 is provided in the longitudinal direction of the heater 300 between the electric conductor 301a and the electric conductor 301b. In addition, the first back surface layer includes a heating element 302a (302a-1 to 302a-7) and a heating element 302b (302b-1 to 302b-7). The heating element 302a is provided between the electric conductor 301a and the electric conductor 303 and configured to generate heat using electricity supplied via the electric conductor 301a and the electric conductor 303. The heating element 302b are provided between the electric conductor 301b and the electric conductor 303 and configured to generate heat using electricity supplied via the electric conductor 301b and the electric conductor 303.

The electric conductor 301, the electric conductor 303, the heating element 302a, and the heating element 302b forms a heat site, which is divided into, for example, seven heat blocks (HB1 to HB7) in the longitudinal direction of the heater 300. That is, the heating element 302a is divided into seven areas, the heating elements 302a-1 to 302a-7, in the longitudinal direction of the heater 300. Note that in Embodiment 1, the heat block HB is divided equally into the seven blocks in the longitudinal direction, but the division need not be made equally. The heating element 302b is divided into seven areas, the heating elements 302b-1 to 302b-7, in the longitudinal direction of the heater 300. The electric conductor 303 is divided into seven areas, the electric conductors 303-1 to 303-7, correspondingly to positions of the division of the heating element 302a and 302b. In Embodiment 1, the heat block HB is divided into the seven blocks, which however does not limit how to divide the heat block HB. Hereinafter, the heat blocks HB1 to HB7 will be denoted as HB(1) to HB(7) in some cases. The heater 300 includes a plurality of heat generation devices, the heat block HB1 to HB7, disposed in the longitudinal direction. The first back surface layer includes the electrode E (E1 to E7, E8-1 and E8-2). The electrodes E1 to E7 are provided in areas of the electric conductors 303-1 to 303-7, respectively, and serve as electrodes configured to supply electricity to the heat blocks HB1 to HB7 via the electric conductors 303-1 to 303-7. The electrodes E8-1 and E8-2 are provided at ends of the heater 300 in the longitudinal direction in such a manner as to be connected to the electric conductor 301, and serve as electrodes configured to supply electricity to the heat blocks HB1 to HB7 via the electric conductor 301.

The second back surface layer is formed of a surface protection layer 307 having an insulation property (e.g., glass in Embodiment 1) and covers the electric conductor 301, the electric conductor 303, and the heating elements 302a and 302b (see FIG. 2A). The surface protection layer 307 is formed except for spots of the electrode E. In other words, the electrode E is not covered with the surface protection layer 307 but exposed to an outside. Therefore, the heater 300 has a configuration that enables the electric contact C to be connected to the electrode E on a second back surface layer side of the heater 300.

The first sliding surface layer, which is provided on a surface of the substrate 305 opposite to the first back surface layer, includes thermistor TH (TH1-1 to TH1-4 and TH2-5 to TH2-7), which is a temperature sensing unit configured to sense temperatures of the heat blocks HB1 to HB7. The first sliding surface layer is provided with electric conductor ET (ET1-1 to ET1-4 and ET2-5 to ET2-7) correspondingly to the thermistor TH (TH1-1 to TH1-4 and TH2-5 to TH2-7). The first sliding surface layer is also provided with electric conductor EG (EG1 and EG2). The second sliding surface layer is formed of a surface protection layer 308 having a slidability and an insulation property (e.g., glass in Embodiment 1) and is configured to cover the thermistor TH, the electric conductor ET, and the electric conductor EG of the first sliding surface layer and to ensure a slidability between the second sliding surface layer and an inner surface of the fixing film 212. The surface protection layer 308 is formed except for both ends of the heater 300 in the longitudinal direction so as to provide electric contacts for the electric conductor ET and the electric conductor EG. That is, the electric conductor ET (ET1-1 to ET1-4 and ET2-5 to ET2-7) and the electric conductor EG (EG1 and EG2) are exposed to the outside at both ends in the longitudinal direction.

Next, how to connect the electric contact C to the electrode E will be described. FIG. 2C is a plan view of the electric contact C connected to the electrode E when viewed from the heater holding member 211. The heater holding member 211 is provided with through holes at positions corresponding to the electrode E (E1 to E7, and E8-1 and E8-2). At the positions of the through holes, the electric contact C (C1 to C7, and C8-1 and C8-2) are electrically connected to the electrode E (E1 to E7, and E8-1 and E8-2) by means of, for example, urging force of springs or welding.

[Configuration of Heating Area]

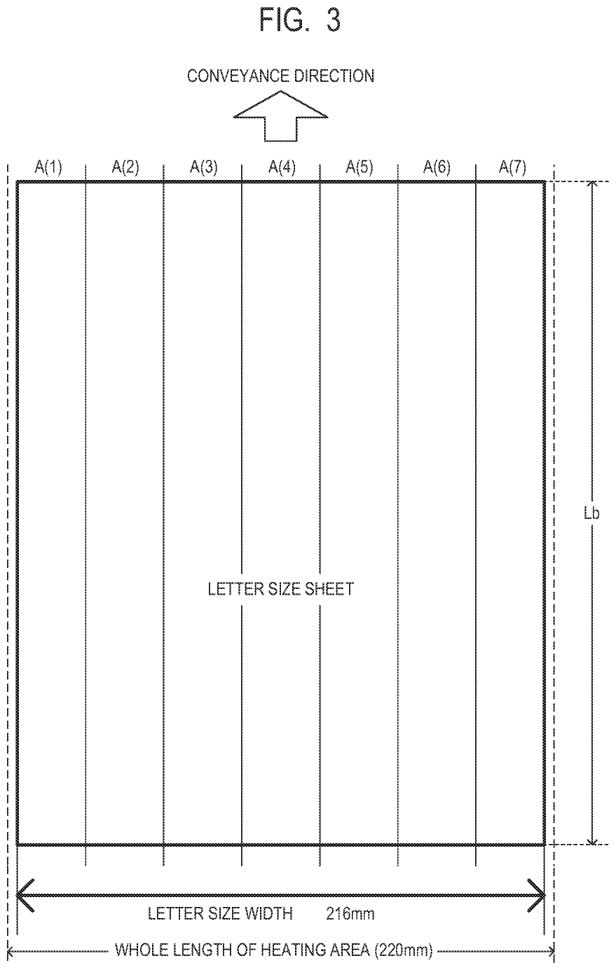

FIG. 3 is a diagram illustrating seven heating areas A(i) (i=1 to 7) divided in the longitudinal direction in Embodiment 1, which are illustrated together with a size of a letter size sheet (bold solid line) for comparison. Here, i is information indicating a position of a heat block HB(i) or a heating area A(i) in the heater 300 and will be referred to hereinafter as positional information i. Assuming long sides of the letter size sheet are in the conveyance direction, the letter size sheet has a length in the direction orthogonal to the conveyance direction (hereinafter, referred to as a width) (letter size width) of 216 mm. In addition, a length of the recording material P in the conveyance direction is denoted by Lb. The heating areas A(i) correspond to the heat block HB1 to HB7 of the heater 300, illustrated in FIG. 2A to FIG. 2C. That is, the heat block HB1 heats a heating area A(1), the heat block HB2 heats a heating area A(2), . . . , and the heat block HB7 heats a heating area A(7). A heating area A(i) corresponding to a heat block HB(i) is an area in a strip shape extending in the conveyance direction, as illustrated in FIG. 3. In Embodiment 1, a whole length of the heating areas A(i) in the longitudinal direction is 220 mm, and a length of each heating area A(i) in the longitudinal direction is a length obtained by dividing the whole length of the heating areas A(i) by 7 (=220 mm/7). Lengths of the heating areas A(i) in the longitudinal direction are equivalent to lengths of the heat blocks HB in the longitudinal direction. Therefore, in a case where the lengths of the heat blocks HB in the longitudinal direction are not equal, the lengths of the heating areas A(i) in the longitudinal direction are made to match the lengths of the heat blocks HB accordingly.

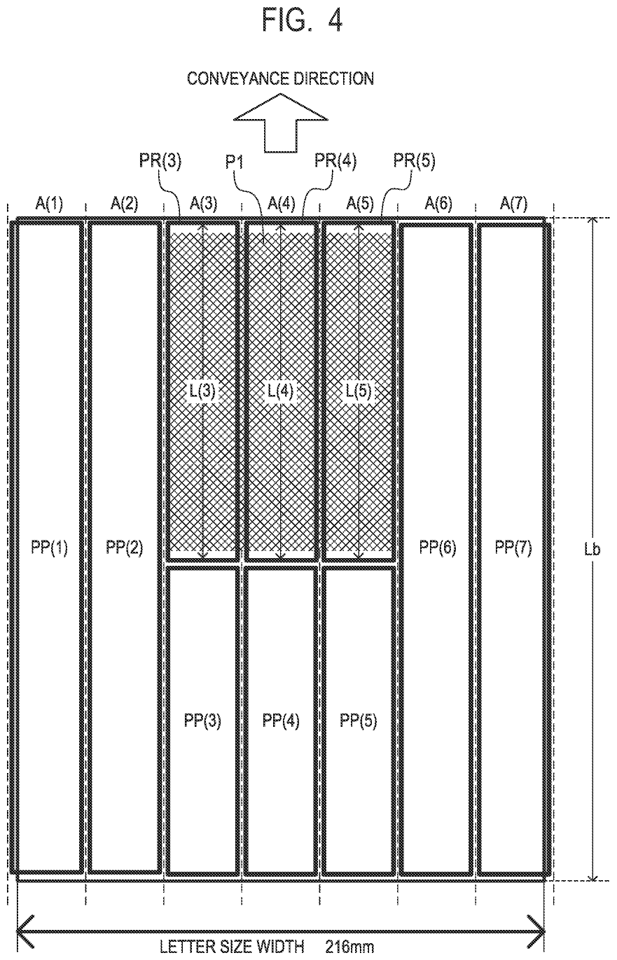

FIG. 4 is a diagram illustrating an image P1 (shaded portion) to be formed on a recording material P and image heating portions PR(i) (i=1 to 7) for the image P1 in Embodiment 1. The image heating portions PR(i) are areas for heating portions on which an image based on image data has been formed in the heating areas A(i), and illustrated by thick-bordered boxes (PR(3) to PR(5)) overlapping the image P1 (shaded portion) in FIG. 4. Lengths of the image heating portion PR(i) in the conveyance direction are denoted by L(i) (specifically, L(3) to L(5)). In addition, zones in the heating areas A(i) excluding the image heating portions PR(i) are defined as non-image heating portions PP(i) (i=1 to 7), which are illustrated by thick-bordered boxes. That is, the heating areas A(i) are formed of the image heating portions PR(i) and non-image heating portions PP(i).

In Embodiment 1, the image P1 is formed in parts of the heating areas A(3) to A(5). The heating areas A(3) to A(5) therefore include the image heating portions PR(3) to PR(5) and non-image heating portions PP(3) to PP(5) in the conveyance direction. Lengths of the image heating portions PR(3) to PR(5) in the conveyance direction are L(3) to L(5). Length of the non-image heating portions PP(3) to PP(5) in the conveyance direction are (Lb-L(3)) to (Lb-L(5)). The image is not formed on whole heating areas A(1) to A(2) and A(6) to A(7) in the conveyance direction. Therefore, whole areas of the heating areas A(1), A(2), A(6) and A(7) are non-image heating portions PP(1), PP(2), PP(6) and PP(7), and there are no image heating portions PR(1), PR(2), PR(6) and PR(7).

[Configuration of Control Unit of Image Forming Apparatus]

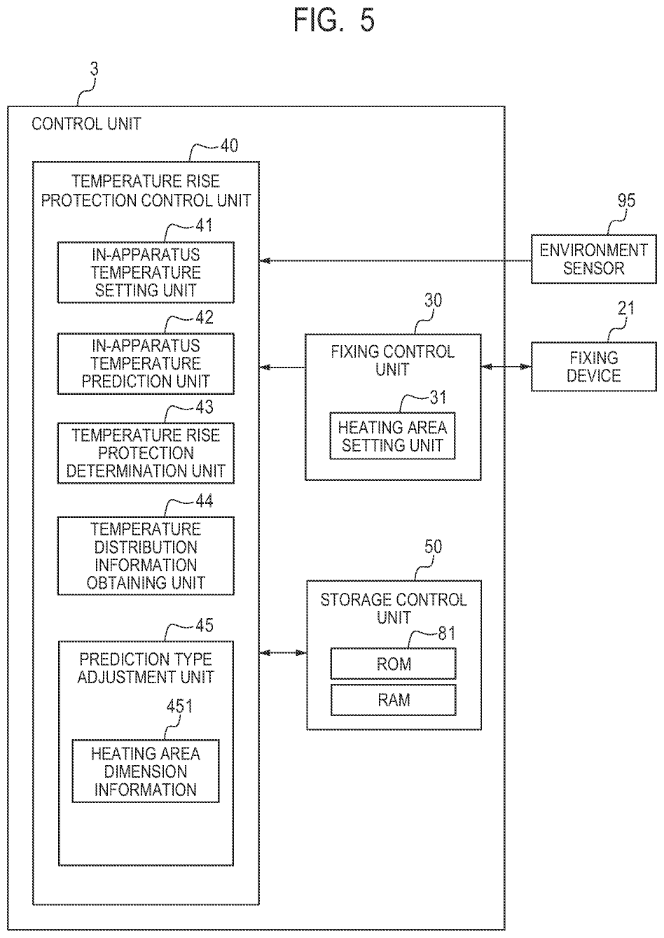

Next, functions of the control unit 3 will be described. FIG. 5 is a functional block diagram of the control unit 3 in Embodiment 1. The functions are implemented by the CPU 80 built in the control unit 3 executing a program stored in the ROM 81. The control unit 3 includes a temperature rise protection control unit 40 (controller unit), a fixing control unit 30, and a storage control unit 50 (storage unit). Of the components, the temperature rise protection control unit 40 is configured to prevent the interior (inside) of the printer 1 from causing an excessive temperature rise in a case where the image forming operation is performed on a recording material P. The temperature rise protection control unit 40 includes an in-apparatus temperature setting unit 41, an in-apparatus temperature prediction unit 42 (prediction unit), a temperature rise protection determination unit 43, a temperature distribution information obtaining unit 44 (obtaining unit), and a prediction type adjustment unit 45 (correction unit). As will be described later in detail, the in-apparatus temperature setting unit 41 is configured to set a temperature of the inside of the image forming apparatus (hereinafter, referred to as an in-apparatus temperature) based on ambient environment information (temperature and humidity) on the printer 1, which is results of sensing by the environment sensor 95 (detection unit). The temperature distribution information obtaining unit 44 is configured to obtain temperature distribution information on a recording material P from a heating area setting for the recording material P notified from the fixing control unit 30. The prediction type adjustment unit 45 is configured to adjust a temperature rise profile based on the temperature distribution information (as an example, heating area dimension information 451 is included). The in-apparatus temperature prediction unit 42 then predicts how the in-apparatus temperature will fluctuate during a period after the printer 1 is turned on until the printer 1 is turned off based on a temperature rise profile for each of operation modes that are preset.

A heating area setting unit 31 (setting unit) included in the fixing control unit 30 is configured to set the image heating portions PR(i) and the non-image heating portions PP(i) in the heating areas A(i) (hereinafter, referred to as a heating area setting) based on image data input from a host computer (not illustrated) or the like. The fixing control unit 30 is configured to control quantities of heat to generate for the heat block HB(i) according to the heating area setting. Specifically, when the non-image heating portions PP(i) pass through the fixing nipping unit N, the fixing control unit 30 controls temperatures of the heat blocks HB(i) so that the temperatures of the heat blocks HB(i) becomes lower than temperatures of the heat blocks HB(i) for when the image heating portions PR(i) described above pass through the fixing nipping unit N. Based on the temperature rise profile adjusted (corrected) by the prediction type adjustment unit 45, the above-described in-apparatus temperature prediction unit 42 predicts how the in-apparatus temperature will fluctuate. The temperature distribution information used for the adjustment is obtained based on the heating area setting, and thus using the temperature distribution information enables improvement of an accuracy of predicting the in-apparatus temperature. The temperature rise protection determination unit 43 determines whether the in-apparatus temperature predicted by the in-apparatus temperature prediction unit 42 has reached a predetermined threshold value, and when determining that the predetermined threshold value has been reached, the temperature rise protection determination unit 43 switches an operation mode of the printer 1 to a temperature rise protection mode. Here, the temperature rise protection mode refers to, for example, an operation that alternates the image forming operation and a suspending operation at an interval of a certain time period (hereinafter, referred to as an intermittent operation). In the temperature rise protection mode such as the intermittent operation, a throughput of the printer 1 decreases as compared with regular operation modes. Here, the throughput is expressed as a number of recording materials P on which images are formed by the printer 1 per unit time. The storage control unit 50 includes ROM 81 and RAM and is configured to store information to be used by the control units included in the temperature rise protection control unit 40.

[Outline of Temperature Rise Protection Control]

Next, the temperature rise protection control unit 40 as illustrated in FIG. 5 will be described in detail. The temperature rise protection control unit 40 prevents the interior of the printer 1 from causing an excessive temperature rise when the double-side-print is performed on a recording material P. This is because an excessive temperature rise of the interior of the printer 1 can affect a quality of an image to be formed on the recording material P. In Embodiment 1, as the in-apparatus temperature of the printer 1, pay attention to temperatures of the drum cleaners 10 and the belt cleaner 25, which are processing members.

The drum cleaners 10 and the belt cleaner 25 cause the respective blades to abut the image bearing members to be clean (the photosensitive drums 11 or the intermediate transfer belt 17), so as to remove (clean out) toners that are not transferred but left on the image bearing members after image formation. At this point, the blades rub the image bearing members, causing temperature rises under influence of friction. Toner has a property of melting by heat. Therefore, when temperatures of the blades reach around a fusing point of toner, fusion of toner occurs at edges of the blades, which brings about poor cleaning. That is, melted toner passes a blade and can affect a quality of an image to be formed next.

The temperature rise protection control unit 40 therefore performs control to switch the operation mode of the printer 1 to the temperature rise protection mode before the temperatures of the blades rise to a temperature at which the poor cleaning can occur. Here, the temperature rise protection mode is a mode in which the printer 1 is operated in such a manner as not to increase the temperatures of the blades, and the intermittent operation that alternates the image forming operation and the suspending operation at an interval of a certain time period is included in the temperature rise protection mode. When the operation mode of the printer 1 is switched to the temperature rise protection mode, the throughput decreases.

As described with reference to the functional block diagram of FIG. 5, in Embodiment 1, the temperature rise protection control unit 40 is configured to predict the temperatures of the blades based on an ambient temperature and an ambient humidity of the printer 1 sensed by the environment sensor 95 and the temperature rise profile preset for each of the operation modes. A possible method is to dispose temperature sensors in proximities to the blades to directly sense the temperatures of the blades, which can sense the temperatures with high accuracy. This method however increases the apparatus in size. In addition, this method requires disposing the sensors by a number of blades temperatures of which are to be sensed, which results in an increase in cost. Therefore, the above-described predictive control is performed in Embodiment 1.

In order to predict the in-apparatus temperature of the printer 1 in a case where the double-side-print is performed on a recording material P, it is necessary to take into account a quantity of heat carried from a recording material P on a front surface of which a toner image is fixed and heated to the processing members of the printer 1. In a case of the printer 1 in Embodiment 1, when a recording material P on a front surface of which an toner image is fixed and heated passes through the second transfer nipping unit (see FIG. 1A), a quantity of heat of the recording material P is carried to the intermediate transfer belt 17. As the intermediate transfer belt 17 causes a temperature rise, the blade of the belt cleaner 25 causes a temperature rise accordingly. In addition, as the intermediate transfer belt 17 causes a temperature rise, the photosensitive drums 11 abutting the intermediate transfer belt 17 also cause temperature rises, and blades of the drum cleaners 10 cause temperature rises accordingly. Therefore, in performing the double-side-print on a recording material P, an increase rate in the in-apparatus temperature of the printer 1 is high as compared with a case where the single-side-print is performed on a recording material P.

An actual quantity of heat carried from a recording material P to the processing member varies according to how much a temperature of the recording material P on a front surface of which a toner image is fixed and heated rises. As described with reference to the functional block diagram of FIG. 5, the temperature rise protection control unit 40 is configured in Embodiment 1 to predict the in-apparatus temperature of the printer 1 using the information obtained from the environment sensor 95, the temperature rise profile for the operation mode, and in addition, temperature distribution information based on a heating area setting for a recording material P. The prediction enables the in-apparatus temperature of the printer 1 to be predicted more accurately than conventional prediction methods.

[Temperature Rise Protection Control Processing]

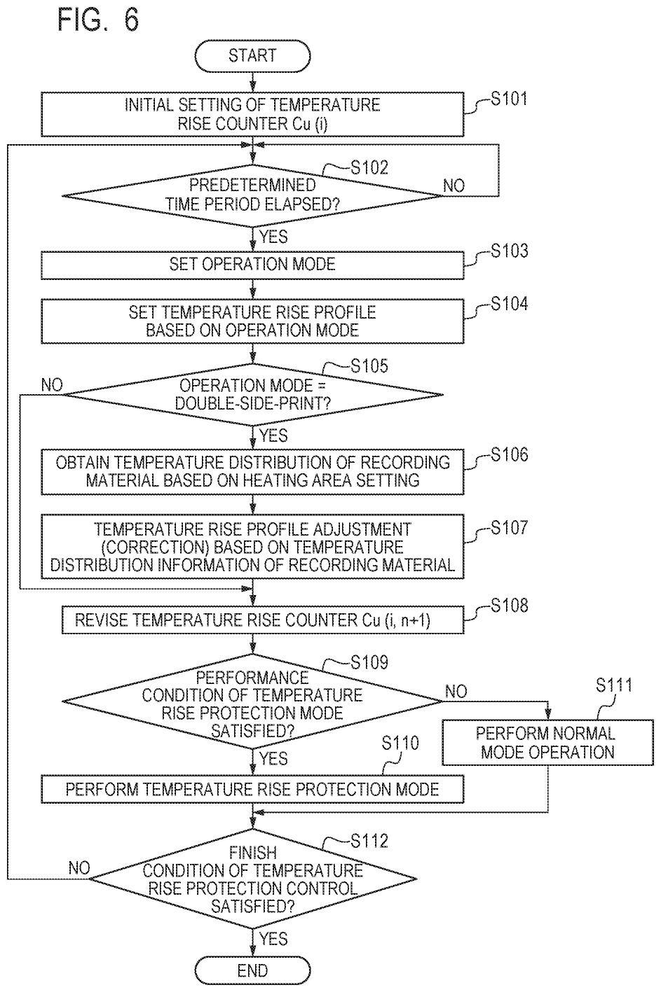

A flow of the temperature rise protection control in Embodiment 1 will be described with reference to a flowchart of FIG. 6. Control based on the flowchart of FIG. 6 is performed by the CPU 80 built in the control unit 3 based on a program stored in the ROM 81.

In the flowchart of FIG. 6, the control unit 3 starts step (hereinafter, abbreviated as S) 101 and subsequent processes at a time when the printer 1 is turned on. In S101, the control unit 3 causes the environment sensor 95 to sense ambient environment information (temperature and humidity) (hereinafter, referred to as an environment temperature Te) on the printer 1 and sets initial values of temperature rise counters Cu(i). In S102, the control unit 3 determines whether a predetermined time period has elapsed from the sensing of the environment information or a previous update of the temperature rise counters Cu(i) to perform update of the temperature rise counters Cu(i) every predetermined time period. Here, the temperature rise counters Cu(i) are parameters corresponding to the in-apparatus temperature of the printer 1, which includes, in Embodiment 1, temperatures of the blades of the drum cleaners 10 at positions (the position information i) corresponding to heating areas A(i) for a recording material P. That is, there are more than one temperature rise counters Cu(i) provided correspondingly to the heating areas A(i). For example, in the heater 300 described with reference to FIG. 2A to FIG. 2C, there are seven temperature rise counters Cu(i) (i=1 to 7) provided correspondingly to the heating areas A(1) to A(7) corresponding to the seven heat blocks HB(1) to HB(7). In such a manner, a temperature rise counter for the position information i is denoted as Cu(i), and an in-apparatus temperature for the position information i (a temperature of a blade) is denoted as T(i). The control unit 3 adds values of the temperature rise counters Cu(i) to the environment temperature Te sensed in S101, so as to obtain the temperatures of the blades (in-apparatus temperatures) T(i) at the positions corresponding to the heating areas A(i) (see Formula (3) described later).

When determining in S102 that the predetermined time period has not elapsed, the control unit 3 returns the processing to S102. When determining that the predetermined time period has elapsed, the control unit 3 advances the processing to S103. In S103, the control unit 3 sets the operation mode. In S104, the control unit 3 sets a temperature rise profile used for prediction of the in-apparatus temperatures based on the operation mode set in S103. Here, the operation mode indicates a state of the printer 1 and broadly classified into, for example, a normal mode and a temperature rise protection mode. The normal mode includes modes such as the single-side-print, the double-side-print, and stand-by. The temperature rise profiles are data indicating how the temperatures of the blades (the in-apparatus temperatures) fluctuates with time from entering the respective operation modes, that is, characteristics of changes in the temperatures. The temperature rise profiles are created for the respective operation modes based on information obtained in advance through, for example, experiments and stored in the ROM 81. The temperature rise profiles will be described later.

In S105, the control unit 3 determines whether the operation mode is the double-side-print. When determining in S105 that the operation mode is the double-side-print, the control unit 3 advances the processing to S106, and when determining that the operation mode is not the double-side-print, the control unit 3 advances the processing to S108. In S106, the control unit 3 obtains the temperature distribution information on the recording material P based on the heating area setting set by the heating area setting unit 31 (e.g., FIG. 4). In S107, based on the temperature distribution information on the recording material P obtained in S106, the control unit 3 causes the prediction type adjustment unit 45 to adjust (correct) the temperature rise profile set in S104. This adjustment can reflects an influence of a temperature distribution of the recording material P on the in-apparatus temperatures in predicting the in-apparatus temperatures, which enables the in-apparatus temperatures (the temperatures of the blades) to be predicted with accuracy. In S108, the control unit 3 uses the temperature rise profile adjusted in S107 to update the temperature rise counters Cu(i). In a case where the operation mode is not the double-side-print (N in S105), the control unit 3 updates the temperature rise counter Cu(i) using the temperature rise profile set in S104 as it is (as left not corrected). Here, assume that current temperature rise profiles are denoted as Cu(i, n), and updated temperature rise profiles are denoted as Cu (i, n+1). An adjustment (correction) method for the temperature rise profiles Cu(i, n), and an update method for the temperature rise counters Cu(i) will be described later in detail.

In S109, the control unit 3 determines whether the predicted in-apparatus temperatures (the temperature rise profile Cu(i, n+1) in S108) reach a protection threshold value stored in the ROM 81, that is, whether a condition for entering the temperature rise protection mode has been satisfied. Here, the protection threshold value is set at, in Embodiment 1, a temperature lower than a temperature at which the poor cleaning occurs. When determining in S109 that the in-apparatus temperatures have reached the protection threshold value, the control unit 3 advances the processing to S110, and when determining that the in-apparatus temperatures have not reached the protection threshold value, the control unit 3 advances the processing to S111. In S110, the control unit 3 switches the operation mode of the printer 1 to the temperature rise protection mode to perform an operation in the temperature rise protection mode. As the temperature rise protection mode, the control unit 3 performs the intermittent operation that alternates the image forming operation and the suspending operation at an interval of a certain time period in Embodiment 1. Here, in the suspending operation, all motors that need not be driven are stopped, and in a case where the printer 1 includes a cooling fan (not illustrated), the cooling fan is driven, for example, at full speed to cool the interior. Note that, in Embodiment 1, the control unit 3 switches the operation mode to the temperature rise protection mode in a case where one of the in-apparatus temperatures (the temperature rise counters Cu(i)) has reached the protection threshold value.

In contrast, in a case where the in-apparatus temperatures have not reached the protection threshold value, the control unit 3 switches the operation mode of the printer 1 to the normal mode in S111 to perform the normal image forming operation and advances the processing to S112. In S112, the control unit 3 determines whether a condition for terminating the temperature rise protection control (hereinafter, referred to as a termination condition) has been satisfied, and when determining that the termination condition has not been satisfied, that is, when the temperature rise protection control is to be continued, the control unit 3 returns the processing to S102. When determining in S112 that the termination condition has been satisfied, that is, when the temperature rise protection control is not to be continued, the control unit 3 terminates the control of the flowchart. In Embodiment 1, the temperature rise protection control is terminated at a time when, for example, the printer 1 is turned off.

[Temperature Rise Counter]

In Embodiment 1, the in-apparatus temperatures (the temperature T(i) of the blades) are denoted as the temperature rise counters Cu(i) that are updated every predetermined time period. The temperature rise counters Cu(i) are set at an initial value at a time when the printer 1 is turned on, and then are updated every predetermined time period. The initial value is determined according to an elapsed time from when the printer 1 is turned off last time until the printer 1 is turned on, based on temperature rise counters Cu(i) of the time when the printer 1 is turned off last time. For example, in a case where a time sufficient to bring the in-apparatus temperatures to a same temperature as a surrounding environment has elapsed, the initial value of the temperature rise counters Cu(i) is set at zero (Cu(i)=0). In general, a temperature change rate of the in-apparatus temperatures lowers with time, and therefore the in-apparatus temperatures have a tendency to converge to a certain temperature finally. In order to make the temperature rise counters Cu(i) have such characteristics, amounts of change ΔCu(i, n) in the temperature rise counters Cu(i) in the predetermined time period for processing members for which the in-apparatus temperatures are to be predicted are calculated as shown in Formula (1). In the calculation of the amounts of change ΔCu(i, n) of the temperature rise counters Cu(i), temperature fluctuation coefficients k(i), convergence counters Cx(i), and the current temperature rise counters Cu(i, n) at the positions (position information i) corresponding to heating areas A(i) are used. Note that a unit of the parameters representing the temperatures is 0.0001° C. in Embodiment 1. Here, n denotes a value corresponding to a timing of the update (a parameter corresponding to the time).

ΔCu(i, n)=k(i)×(Cx(i)−Cu(i, n)) (1)

Next, Formula (2) is used to add the amounts of change ΔCu(i, n) determined by Formula (1) to the current temperature rise counters Cu(i, n), updating the temperature rise counters Cu(i, n+1). This calculation is equivalent to S108 in FIG. 6.

Cu(i, n+1)=Cu(i, n)+ΔCu(i, n) (2)

Then, the in-apparatus temperatures T(i) are calculated from the updated temperature rise counters Cu (i, n+1) and the environment temperature Te by Formula (3).

T(i)=Cu(i, n+1)+Te (3)

The control unit 3 then determines whether the in-apparatus temperatures T(i) corresponding to the heating areas A(i) have reached a protection threshold value Ts, which is a first temperature (T(i)≥Ts). In the example of the heater 300 illustrated in FIG. 2A to FIG. 2C, in a case where at least one in-apparatus temperature T(i) of the seven in-apparatus temperatures T(1) to T(7) has reached the protection threshold value Ts, the control unit 3 switches the operation mode of the printer 1 to the temperature rise protection mode, which is a second state. In contrast, in a case where all of the in-apparatus temperatures T(i) fall below a return threshold value Tr, which is a second temperature (T(i)<Tr), the control unit 3 switches the operation mode of the printer 1 to the normal mode, which is a first state. In Embodiment 1, for example, a protection threshold value Ts=450000 (a value equivalent to 45° C.) and a return threshold value Tr=410000 (a value equivalent to 41° C.) are used.

In Embodiment 1, the temperature rise profile is set according to the operation mode, as described in the description of S104 in FIG. 6. The temperature rise profile mentioned here includes the temperature fluctuation coefficients k(i) and the convergence counters Cx(i) used to update the temperature rise counters Cu(i, n). The temperature fluctuation coefficients k(i) are parameters each representing a magnitude and a direction of a temperature fluctuation in a certain time period (an increase rate or decrease in temperature). The convergence counters Cx(i) are parameters representing temperatures to which the in-apparatus temperatures T(i) converge after a lapse of a predetermined time period from switching to an operation mode in question. In particular, in the double-side-print, the temperature rise profile is adjusted (corrected) in S107 in FIG. 6 using the temperature distribution information based on the heating area setting obtained by the temperature distribution information obtaining unit 44. This adjustment reflects an influence of a temperature distribution of a recording material P on the in-apparatus temperatures to the temperature rise profile.

[Measured Value and Predicted Value of In-Apparatus Temperature]

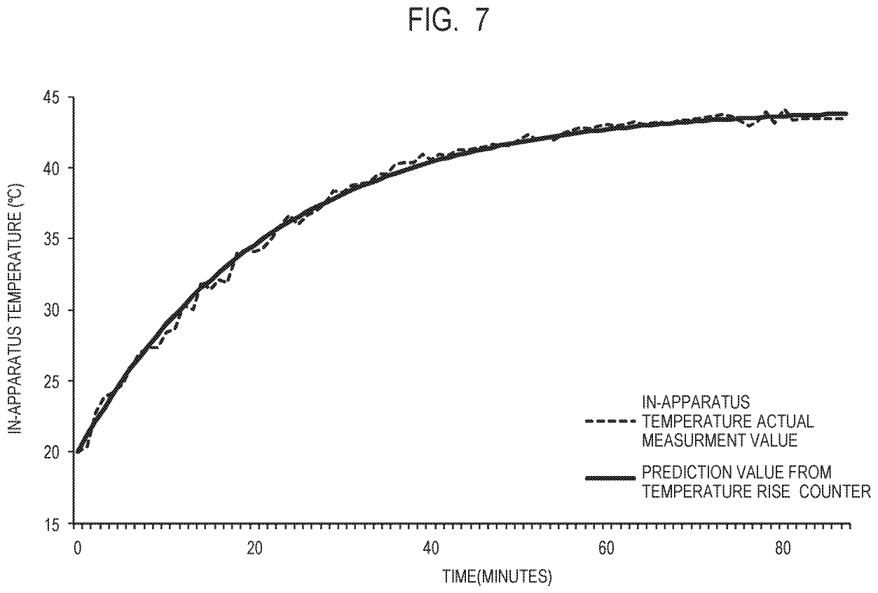

FIG. 7 is a graph in which measured values of the in-apparatus temperature obtained when the double-side-print is performed consecutively at an environment temperature Te=25° C. overlaps predicted values (T(i)) of the in-apparatus temperature obtained using the temperature rise counter Cu(i, n). In FIG. 7, an abscissa represents time (minute), and an ordinate represents the in-apparatus temperature (° C.). A broken line indicates the measured values of the in-apparatus temperature, and a solid line indicates the predicted values (T(i)) of the in-apparatus temperature obtained using the temperature rise counter Cu(i, n) in Embodiment 1. Here, the measured value of the in-apparatus temperature is a temperature sensed by a temperature sensor attached to a cartridge and represents a temperature of the blade of the drum cleaner 10 indirectly. The cartridge is formed integrally by the photosensitive drum 11, the charging roller 12, the developing unit 14, the developer conveyance roller 15, and the drum cleaner 10 as one unit, and is detachable from the printer 1. Members involved in forming a toner image unfixed on a recording material P, such as the optical unit 13, the cartridge, the primary transfer roller 16, the intermediate transfer belt 17, the belt cleaner 25, the secondary transfer roller 19 will be referred to as image forming units. As seen from FIG. 7, the temperature rise counter Cu(i, n) used for the predicted value of the in-apparatus temperature in Embodiment 1 enables a temperature rise phenomenon of the interior to be approximated with accuracy.

[Adjustment (Correction) Based on Temperature Distribution Information]

In Embodiment 1, the control unit 3 adjusts (corrects) in S107 in FIG. 6 the temperature rise profile taking into consideration an influence of the temperature distribution information based on a heating area setting for a recording material P on the in-apparatus temperatures. Specifically, with L(i) denoting lengths of image heating portions PR(i) in heating areas A(i) in the conveyance direction and Lb denoting a length of a recording material P as a reference in conveyance direction, Formula (4) is used to obtain correction coefficients α(i) based on dimensions of the image heating portions PR(i) (hereinafter, referred to as image heating portion dimensions). Here, length of the heating areas A(i) in the longitudinal direction are assumed to be equal to each other in Embodiment 1.

α(i)=L(i)÷Lb (4)

A base temperature rise profile is provided, which includes a base temperature fluctuation coefficients kb(i) and a base convergence counters Cxb(i). The base temperature rise profile (kb(i), Cxb(i)) includes values measured under a condition that the lengths of the image heating portions PR(i) in the conveyance direction are equal to the length of the recording material P in the conveyance direction (L(i)=Lb), and Lb=279.4 mm (letter size sheet) in Embodiment 1.

In Embodiment 1, in a case where L(i)<Lb (e.g., in the case of FIG. 4), it is possible to consider that a recording material P on a front surface of which a toner image is fixed and heated has a small influence on the in-apparatus temperatures as compared with a case of the reference. That is, the smaller the image heating portion dimensions are, the lower the increase rate in in-apparatus temperatures are, and the lower a converged value of the temperature becomes. With the above taken into consideration, a temperature rise profile (k1(i), Cx1(i)) based on a correction coefficient a according to the image heating portion dimensions is calculated as shown in Formula (5). The temperature rise profile (k1(i), Cx1(i)) is a temperature rise profile with the correction based on the temperature distribution of the recording material P.

(k1(i), Cx1(i))=α(i)×(kb(i), Cxb(i)) (5)

A setting example of temperature rise profiles adjusted in the above manner is shown in Table 1.

TABLE 1

| | Correction | Temperature rise profile | |
|---|---|---|---|
| | coefficient α(i) | Temperature | |
| | according to image | fluctuation | Convergence |
| Operation | heating portion | coefficient | counter |
| mode | dimensions | k1(i) | Cx1(i) |
| Single- | | 0.0028 | 270000 |
| side-print | | | |
| Double- | 100% (Base) | 0.0032 | 290000 |
| side-print | 95% | 0.0030 | 275500 |
| | 89% | 0.0028 | 258100 |
| Standby | | 0.0016 | 16000 |

Table 1 gives, from the left, operation modes such as the single-side-print, correction coefficients α(i) (shown in %) according to image heating portion dimensions, and temperature fluctuation coefficients k1(i) and convergence counters Cx1(i) of the temperature rise profiles. The temperature rise profiles are stored in the ROM 81 of the storage control unit 50 being associated with the operation modes. For example, in an operation mode of the double-side-print, the base temperature rise profile (100%) is (kb(i), Cxb(i))=(0.0032, 290000). This base temperature rise profile indicates that a temperature rise of up to +29° C. (converged temperature) with reference to the environment temperature Te is expected, and a magnitude of a temperature change in the certain time period is (converged temperature−current temperature)×0.32%. Based on this base temperature rise profile, adjustments by Formula (5) are made according to the correction coefficient α(i) (e.g., 95%, 89%) according to the image heating portion dimension.

In Embodiment 1, an influence of non-image heating portions PP(i) on the in-apparatus temperatures is ignored for ease of description, and it is possible to use correction coefficients with the influence of the non-image heating portions PP(i) on the in-apparatus temperatures factored in. For example, as with Formula (4), correction coefficients ε(i) according to dimensions of the non-image heating portions PP(i) (hereinafter, referred to as non-image heating portion dimensions) may be calculated, and a result of weighted average of the correction coefficients ε(i) and α(i) may be used for correction as in Formula (5). Alternatively, another kind of correction coefficient may be used for the temperature fluctuation coefficients k(i) and the convergence counters Cx(i). As seen from the above, any method that corrects the temperature rise profiles based on dimensions of heating areas A(i) of the heater 300 for a recording material P can be used.

As described above, in Embodiment 1, in order to predict the in-apparatus temperatures in the double-side-print, the temperature rise profile used for the prediction of the in-apparatus temperatures are adjusted (corrected) using the correction coefficients α(i) according to the image heating portion dimensions. This adjustment enables the influence of the temperature distribution of the recording material P on the front surface of which a toner image is fixed and heated on the in-apparatus temperatures to be taken into consideration to predict the in-apparatus temperatures. The prediction therefore enables reduction of unnecessary performance of the temperature rise protection mode, reducing downtime.

In Embodiment 1, the described example is one in which the recording material P is a letter size sheet, and therefore a dimension ratio of the image heating portions PR(i) can be calculated from a ratio between lengths in the conveyance direction. In a case of a recording material P of another size, lengths of image heating portions PR(i) of the recording material P in the direction orthogonal to the conveyance direction are shorter than the heating areas A(i) in some cases. In this case, by using not only the lengths L(i) of the image heating portions PR(i) in the conveyance direction but also lengths W(i) of the image heating portions PR(i) in the direction orthogonal to the conveyance direction, the correction coefficients α(i) according to image heating portion dimensions can be obtained from a dimension ratio. Also in this case, the temperature rise profile is corrected according to the dimensions of the heating areas A(i).

As seen from the above, the in-apparatus temperatures can be predicted with high accuracy according to Embodiment 1.

### Embodiment 2

In Embodiment 2, when the temperature rise profile is adjusted based on the temperature distribution information based on the heating area setting, correction according to characteristics and configurations of a processing member corresponding to heating areas A(i) for a recording material P is also performed. A major part of Embodiment 2 is the same as a major part of Embodiment 1, and thus only differences of Embodiment 2 from Embodiment 1 will be described.

[Adjustment Based on Characteristics and Configurations of Processing Member Corresponding to Heating Areas]

As described above, in Embodiment 1, the temperature rise profile is corrected based on the correction coefficients α(i) according to the image heating portion dimensions. However, a tendency for the in-apparatus temperatures T(i) to fluctuate differs according to the characteristics and the configurations of the processing member corresponding to heating areas A(i) for a recording material P. For example, a member close to a fan for cooling the interior gives a gentle rising curve of the in-apparatus temperatures. Thus, the closer a processing member is to the fan, the lower an increase rate in temperature the processing member has and the lower temperature a temperature of the processing member converges to after a lapse of a predetermined time period. In addition, in a case where a member easy to rise in temperature is used, the in-apparatus temperatures T(i) each give a steep rising curve. In Embodiment 2, therefore, the temperature rise profile in Embodiment 1 is corrected according to the characteristics and the configurations of the processing member corresponding to heating areas A(i) for a recording material P. Specifically, for the base temperature rise profile (kb(i), Cxb(i)), Formula (6) is used to calculate a corrected temperature rise profile (k2(i), Cx2(i)).

(k2(i), Cx2(i))=β(i)×(kb(i), Cxb(i)) (6)

Here, β(i) are correction coefficients according to the characteristics and the configurations of the processing member corresponding to the heating areas A(i). As an example, a setting example of the correction coefficients β(i) and the corrected temperature rise profiles in a case where a fan for cooling the interior is placed close to a member corresponding to the heating area A(1) is shown in Table 2.

TABLE 2

| | Correction coefficient | | |
|---|---|---|---|
| | β(i) according to | Temperature rise profile | |
| | characteristics and | Temperature | |
| | configurations of | fluctuation | Convergence |
| Heating | member corresponding | coefficient | counter |
| area i | to heating areas | k2(i) | Cx2(i) |
| 1 | 90% | 0.0029 | 261000 |
| 2 | 95% | 0.0030 | 275500 |
| 3 | 100% (Base) | 0.0032 | 290000 |
| 4-6 | | | |
| 7 | | | |

Table 2 gives, from the left, the position information i on the heating areas A(i), the correction coefficients β(i) according to the characteristics and the configurations of the member corresponding to the heating areas A(i), the temperature fluctuation coefficients k2(i) of the temperature rise profile, and the convergence counters Cx2(i) of the temperature rise profile. As an example, for positions corresponding to the heating areas A(1) and A(2) of a processing member placed close to the fan, a correction coefficient β(1) is 90%, and a correction coefficient β(2) is 95%. In contrast, for positions corresponding to the heating areas A(3) to A(7) of a processing member placed further from the fan, correction coefficients β(3) to β(7) are 100%, the same as the base temperature rise profile. In addition, temperature rise profiles corrected using the correction coefficients β(i) are also corrected according to a positional relation between the fan and a processing member in question. Specifically, the correction is made such that the temperature rise profile (k2(i), Cx2(i)) is made larger for a position of the processing member further from the fan.

[Configuration of Control Unit of Image Forming Apparatus]

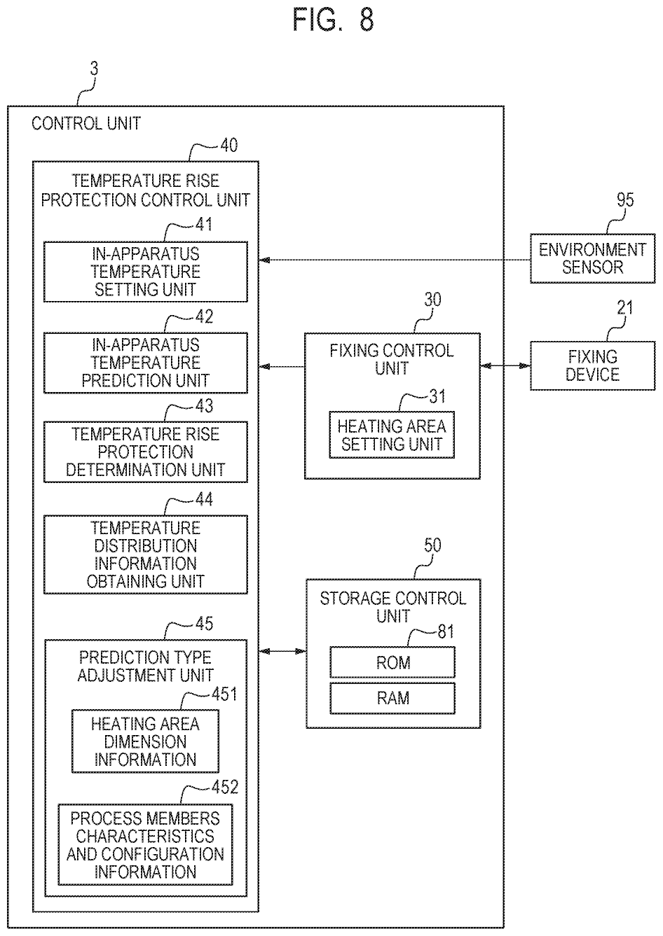

A functional block diagram of a control unit 3 in Embodiment 2 is illustrated in FIG. 8. A difference of the control unit 3 from the control unit 3 in Embodiment 1 is in that process members characteristics and configuration information 452 is added to the information used by the prediction type adjustment unit 45. Same components as respective counterparts in FIG. 5 have the same reference numerals and will not be described.

As described above, in Embodiment 2, the temperature rise profile is corrected according to the characteristics and the configurations of the processing member corresponding to the heating areas A(i). In addition, the correction can be used in combination with Embodiment 1 as shown in Formula (7). A method to combine the correction and Embodiment 1 is not limited only to Formula (7), and another method such as assigning weights to the correction coefficients α(i) and the correction coefficients β(i) according to degree of influence can be used.

(k2(i), Cx2(i))=α(i)×β(i)×(kb(i), Cxb(i)) (7)

As described above, in Embodiment 2, the temperature rise profile is adjusted according to the characteristics and the configurations of the processing member corresponding to the heating areas A(i), and thus the in-apparatus temperatures can be predicted according to an environment of the interior. As a result, unnecessary performance of the temperature rise protection mode can be reduced, preventing a degradation in usability.

In addition to the adjustment of the temperature rise profile as with Embodiment 2, the protection threshold value Ts and the return threshold value Tr can be changed according to the characteristics and the configurations of the processing member corresponding to the heating areas A(i). Moreover, the correction coefficients β(i) may be made changeable according to a control state such as a driving status of the fan. The method in Embodiment 2 can be applied also to operation modes other than the double-side-print in a case where the temperature rise profile differs according to the characteristics and the configurations of the processing member corresponding to the heating areas A(i).

As seen from the above, the in-apparatus temperatures can be predicted with high accuracy according to Embodiment 2.

### Example 3

In Embodiment 3, when the temperature rise profile is adjusted (corrected) based on the temperature distribution information based on the heating area setting, correction according to positions of heating areas A(i) for a recording material P is also performed. A major part of Embodiment 3 is the same as a major part of Embodiment 1, and thus only differences of Embodiment 3 from Embodiment 1 will be described.

[Adjustment Based on Positions of Heating Areas]

As described above, in Embodiment 1, the temperature rise profile is corrected based on the correction coefficients α(i) according to the image heating portion dimensions. However, a temperature fluctuation of a recording material P on a front surface of which a toner image is fixed and heated until the recording material P reaches the second transfer nipping unit again may vary according to the positions of the heating areas A(i) for a recording material P. For example, edges of a recording material P have large dimensions to be in contact with air and show a tendency to release heat. In this case, in-apparatus temperatures T(i) corresponding to the edges of the recording material P give gentle rising curves.

Hence, in Embodiment 3, the temperature rise profile in Embodiment 1 is corrected according to positions of the heating areas A(i) for a recording material P. Specifically, for the base temperature rise profile (kb(i), Cxb(i)), a control unit 3 calculates a corrected temperature rise profile (k3(i), Cx3(i)) according to rates of elements as shown in Formula (8).

(k3(i), Cx3(i))=γ(i)×(kb(i), Cxb(i)) (8)

Here, γ(i) are correction coefficients according to the positions of the heating areas A(i). A setting example of the correction coefficients γ(i) and adjusted (corrected) temperature rise profiles in a case where both edges of a recording material P tend to release heat and thus have a small influence on the in-apparatus temperatures is shown in Table 3.

TABLE 3

| | Correction | Temperature rise profile | |
|---|---|---|---|
| | coefficient γ(i) | Temperature | |
| | according to | fluctuation | Convergence |
| Heating | positions of | coefficient | counter |
| area i | heating areas | k3(i) | Cx3(i) |
| 1 | 90% | 0.0029 | 261000 |
| 2 | 95% | 0.0030 | 275500 |
| 3-5 | 100% (Base) | 0.0032 | 290000 |
| 6 | 95% | 0.0030 | 275500 |
| 7 | 90% | 0.0029 | 261000 |

Table 3 gives, from the left, the position information i indicating the heating areas A(i), the correction coefficients γ(i) according to the positions of the heating areas A(i), the temperature fluctuation coefficients k3(i) of the temperature rise profile, and the convergence counters Cx3(i) of the temperature rise profile. For example, correction coefficients γ(1) and γ(7) are set at 90% because the heating areas A(1) and A(7), which are both edges of the heater 300, tend to release heat. In contrast, correction coefficients γ(3) to γ(5) for the heating areas A(3) to A(5), which are a center of the heater 300, are set at 100%, the same as the base temperature rise profile. Correction coefficients γ(2) and γ(6) for the heating areas A(2) and A(6), which are positioned between the edges and the center of the heater 300, are set at 95%. In addition, temperature rise profiles corrected using the correction coefficients y(i) are also corrected according to the positions of the heating areas A(i). Specifically, the correction is made such that the temperature rise profile (k3(i), Cx3(i)) is made larger for heating areas A(i) closer to the center in the longitudinal direction.

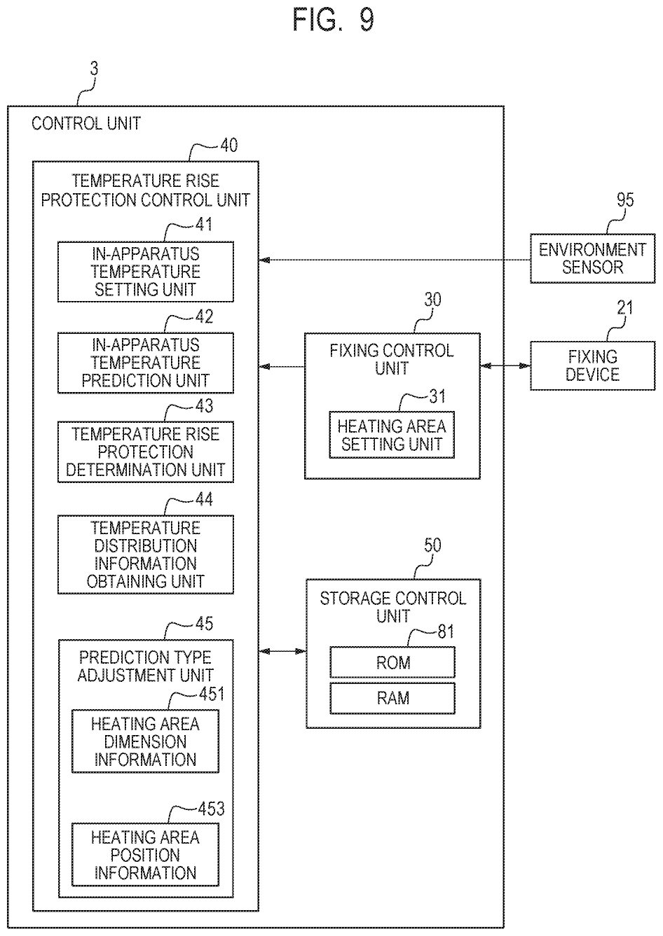

A functional block diagram of the control unit 3 in Embodiment 3 is illustrated in FIG. 9. A difference of the control unit 3 from the control unit 3 in Embodiment 1 is in that heating area position information 453 is added to the information used by the prediction type adjustment unit 45. Same components as respective counterparts in Embodiment 1 have the same reference numerals and will not be described. In a recording material P, an increase rate in temperature of edges is lower than an increase rate in temperature of a center in the longitudinal direction, and a temperature of the edges converging after a lapse of a predetermined time period is lower than a temperature of the center converging after the lapse of the predetermined time period. In Embodiment 3, the temperature rise profile is corrected with the heating area position information 453, which is information relating to the positions of the heating areas A(i) for the recording material P, taken into consideration.

As described above, in Embodiment 3, the temperature rise profile is corrected according to the positions of the heating areas A(i) for a recording material P, and a temperature fluctuation of a recording material P on a front surface of which a toner image is fixed and heated until the recording material P reaches the second transfer nipping unit again can be taken into consideration. The in-apparatus temperatures can be therefore predicted more accurately. As a result, unnecessary performance of the temperature rise protection mode can be reduced, preventing a degradation in usability.

A temperature distribution of a recording material P fluctuates according to a time τ from when a toner image is fixed and heated on a front surface of a recording material P until the recording material P reaches the second transfer nipping unit again. In a case where an image formed on a recording material P is heated selectively, unevenness of the temperature distribution becomes large as the time τ is short, and the temperature distribution becomes uniform as the time τ is long. In a case where such a tendency of fluctuation is taken into consideration, the correction coefficients γ(i) according to the position of the heating area A(i) may be defined as γ(i, τ) to set correction values according to τ.

In addition, in Embodiment 3, the position information i in the direction orthogonal to the conveyance direction is used, but position information j in the conveyance direction may be used to set the correction values, and the correction values set using the position information i and the correction values set using the position information j may be used in combination. For example, in a case of the correction coefficient γ, correction coefficient γ may be set as one of γ(j) and γ(i, j). Moreover, Embodiment 3 may be used in combination with Embodiment 1 and/or Embodiment 2.

As seen from the above, the in-apparatus temperatures can be predicted with high accuracy according to Embodiment 3.

In Embodiments 1 to 3 described above, the cases where the double-side-print is performed on a recording material P have been described, but note that the present invention is not limited to these cases. The control according to the present invention may be applied to a case where the single-side-print is performed on a recording material P.

As seen from the above, the in-apparatus temperatures can be predicted with high accuracy according to the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-126986, filed Jul. 3, 2018, which is hereby incorporated by reference herein in its entirety.

What is claimed is:

1. An image forming apparatus comprising:
an image formation unit configured to form an image on a recording material;
a fixing unit including a plurality of heat generation devices in an orthogonal direction orthogonal to a conveyance direction of the recording material, the fixing unit being configured to fix a toner image unfixed that is formed on the recording material by the image formation unit;
a prediction unit configured to predict a temperature of an inside of the image forming apparatus based on data indicating a characteristic of a change in temperature of the inside of the image forming apparatus; and
a correction unit configured to correct the data based on a temperature distribution of the recording material heated by the plurality of heat generation devices,
wherein the prediction unit predicts the temperature of the inside of the image forming apparatus based on the data corrected by the correction unit.

2. An image forming apparatus according to claim 1, comprising a detection unit configured to sense at least one of an environment temperature and an environment humidity of an environment in which the image forming apparatus is disposed,
wherein the prediction unit is configured to predict the temperature of the inside of the image forming apparatus based further on a result of sensing by the detection unit.

3. An image forming apparatus according to claim 1, comprising a setting unit configured to set areas in which the recording material is heated by the plurality of heat generation devices according to a position of the image formed on the recording material,
wherein the correction unit is configured to obtain the temperature distribution of the recording material based on the areas set by the setting unit.

4. An image forming apparatus according to claim 3, wherein an increase rate in temperature of the recording material becomes low according to smallness of dimensions of the areas, and a temperature converging after a lapse of a predetermined time period becomes low.

5. An image forming apparatus according to claim 1,
wherein the image formation unit includes a member involved in an image forming operation, and
wherein the correction unit is configured to correct the data based on a characteristic in temperature of the member in the orthogonal direction.

6. An image forming apparatus according to claim 5, comprising a fan configured to cool the inside of the image forming apparatus,
wherein the closer the member is to the fan in the orthogonal direction, the lower an increase rate in temperature is and the lower a temperature converging after a lapse of a predetermined time period is.

7. An image forming apparatus according to claim 6,
wherein the image formation unit includes an image bearing member configured to bear a toner image and a blade configured to remove toner left on the image bearing member after image formation, and
wherein the member is the blade.

8. An image forming apparatus according to claim 1, wherein the correction unit is configured to correct the data based on a characteristic in temperature of the recording material in the orthogonal direction.

9. An image forming apparatus according to claim 8, wherein in the recording material, an increase rate in temperature of edges is lower than an increase rate in temperature of a center in the orthogonal direction, and a temperature of the edges converging after a lapse of a predetermined time period is lower than a temperature of the center converging after the lapse of the predetermined time period.

10. An image forming apparatus according to claim 1,
wherein the image forming apparatus is capable of operating in an operation mode including at least double-side-print in which after the fixing unit fixes a toner image on a first surface of the recording material, the image formation unit forms an image on a second surface different from the first surface of the recording material, and
wherein the correction unit is configured to correct the data in a case where the operation mode is the double-side-print.

11. An image forming apparatus according to claim 10, comprising a storage unit configured to store the data,
wherein the data includes data on an increase rate in temperature or a decrease rate in temperature, and data on temperature converging after a lapse of a predetermined time period, is associated with the operation mode, and stored in the storage unit.

12. An image forming apparatus according to claim 1, comprising a control unit configured to switch from a first state in which an image forming operation is performed to a second state in which the image forming operation and a suspending operation for suspending the image forming operation alternate, in a case where the temperature of the inside of the image forming apparatus predicted by the prediction unit reaches a first temperature.

13. An image forming apparatus according to claim 12,
wherein the prediction unit is configured to predict a plurality of temperatures corresponding to the plurality of heat generation devices, respectively, and
wherein the control unit switches from the first state to the second state in a case where at least one of the plurality of temperatures reaches the first temperature.

14. An image forming apparatus according to claim 13, wherein the control unit switches from the second state to the first state in a case where all of the plurality of temperatures fall below a second temperature lower than the first temperature.
